(19) United States
(12) Patent Application Publication
(10) Pub. No.: US 2024/0225037 A1
(43) Pub. Date: Jul. 11, 2024

(54) ICE CREAM STICK

(71) Applicant: Byungyong KIM, Gwacheon-si, Gyeonggi-do (KR)

(72) Inventor: Byungyong KIM, Gwacheon-si, Gyeonggi-do (KR)

(21) Appl. No.: 16/636,010

(22) PCT Filed: Aug. 1, 2018
(86) PCT No.: PCT/KR2018/008754

§ 371 Date: Jan. 25, 2022

(30) Foreign Application Priority Data
Aug. 1, 2017 (KR) 20-2017-0004058

(51) Int. Cl. A23G 9/50

(52) U.S. Cl. CPC A23G 9/503; A23G 2220/12

(57) ABSTRACT

According to an embodiment of the present utility model, an ice-cream bar by recycling waste coffee may be provided. The ice-cream bar by recycling waste coffee may comprise waste coffee powder and a biocompatible binder for combining the waste coffee powder to form the ice-cream bar.

### BACKGROUND OF THE INVENTION

### 1. Field

The present utility model relates to a waste recycling technology, and more particularly, to an ice-cream bar using waste coffee substance.

### 2. Description of the Related Art

As coffee-related culture spreads widely along with the recent increase in living standards, the amount of coffee sludge, which is a waste coffee substance left after producing coffees, is also increasing. Such waste coffee substances generally have harmless properties to the human body. But, they are only recycled as a heat source by using coffee oil contained in wasted coffee, or as a source of fertilizer based on organic content. Most of them are landfilled or incinerated because no special use has been discovered, and thus, the annual cost for disposing waste coffee substances is generated enormously. Therefore, technology for recycling the waste coffee substance can not only reduce processing cost for such disposal, but also can create new added value by discovering new uses, which is very useful in terms of economy.

The waste coffee substances usually have a form of coffee sludge. Dried waste coffee particles obtained from the coffee sludge have a large distribution width in size and shape thereof depending on process variables such as grinding method, heat, and stress magnitude applied to the coffee beans in manufacturing coffee powder or coffee beverage. Therefore, in order to manufacture a product requiring a predetermined strength by using the waste coffee substance, a process to change the particle shape itself or a treatment performed at a high temperature of 400° C. or higher can be required for structural strength improvement of the product.

However, if the waste coffee substance can have the strength suitable for the application without performing the treatment for improving the structural strength, it will be possible to create the above-mentioned added value without the additional cost of the treatment for the strength improvement of the product.

### SUMMARY OF THE INVENTION

The technological object of the present utility model is to provide a coffee recycling technology, wherein waste coffee substance can be usefully recycled by ensuring the required strength through only a simple manufacturing process without changing the shape of the waste coffee particles contained in the coffee sludge or without high temperature treatment.

An ice-cream bar by recycling waste coffee according to an embodiment of the present utility model for realizing the technological object can include waste coffee powder; and a biocompatible binder for combining the waste coffee powder to form an ice-cream bar. In one embodiment, the biocompatible binder can be a biodegradable binder.

The biocompatible binder may include bio-derived soluble substance which is at least any one of chitosan, collagen, gelatin, hyaluronic acid(HA), alginic acid, pectin, carrageenan, chondroitin(sulfate), dextran(sulfate), polylysine, carboxymethyl titin, fibrin, agarose, pullulan and cellulose; biocompatible substances which is at least any one of Polyvinylpyrrolidone(PVP), polyethylene glycol (PEG), polyvinyl alcohol(PVA), hydroxypropyl cellulose(HPC), hydroxyethyl cellulose (HEC), hydroxypropyl methylcellulose(HPMC), sodium carboxymethyl cellulose, polyalcohol, arabic gum, alginate, cyclodextrin, dextrin, glucose, fructose, starch, trehalose, glucose, maltose, lactose, lactulose, fructose, turanose, melitose, melezitose, dextran, sorbitol, xylitol, paratinite, polylactic acid, polyglycolic acid, polyethylene oxide, polyacrylic acid, polyacrylamide, polymethacrylic acid, and polymaleic acid; derivatives of the foregoing substances; or mixtures thereof.

The biocompatible binder may comprise vegetable fiber extracted from any one or more of plants including wood, cotton wool, ramie grass, corn foil, corn stalk, soybean meal, or natural biopolymers. The waste coffee powder may be in the range of 30 wt % to 85 wt % of the total weight of the ice-cream bar by recycling waste coffee.

The biocompatible binder can comprise vegetable fiber extracted from any one or more of plants including wood, cotton wool, ramie grass, corn foil, corn stalk, soybean meal, or natural biopolymers. The waste coffee powder can be in the range of 30 wt % to 85 wt % of the total weight of the ice-cream bar by recycling waste coffee.

In one embodiment, the particles of the waste coffee powder may have an average diameter in the range of 10 μm to 2 mm. The ice-cream bar may further include additives including rice bran, royal coriander, sawdust, grain flour or a mixture thereof. In this case, the additive may be added in the range of 35 wt % or less relative to the total wt %.

The ice-cream bar by recycling waste coffee may constitute a handle or spoon. The ice-cream bar by recycling waste coffee may have any one of a circular cross section, a square cross section, and a rounded square cross section.

According to an embodiment of the present utility model, an ice-cream bar which can recycle waste coffee usefully can be provided, wherein sufficient use strength can be obtained even without a treatment for changing the shape of the waste coffee particles contained in the coffee sludge due to coldness of ice-cream, and in addition, even after disposal, as the strength is easily weakened, so load for disposing the ice-cream bar may be small, and there is no risk of environmental pollution due to biodegradation thereof.

### BRIEF DESCRIPTION OF THE DRAWINGS

FIG. 1A to FIG. 1C are perspective views illustrating ice-cream bars according to various embodiments of the present utility model.

FIG. 2A to FIG. 2C are perspective views illustrating ice-cream bars according to various embodiments of the present utility model.

FIG. 3 is the graph showing experimental results according to embodiments and comparative examples of the present utility model.

### DETAILED DESCRIPTION OF THE INVENTION

Hereinafter, exemplary embodiments of the present utility model will be described in detail with reference to the accompanying drawings.

The embodiments of the present utility model are provided to more fully describe the present utility model to those having a common knowledge in the related art, and the following embodiments can be modified in many different forms. The scope of the present utility model is not limited to the following embodiments. Rather, these embodiments are provided so that this disclosure can be faithfully and completely described, and the concepts of the present utility model can be conveyed completely to those skilled in the related art.

In addition, in the following drawings, the thickness or size of each layer is exaggerated for convenience and clarity of description, and the same reference numerals in the drawings refer to the same elements. As used herein, the term, “and/or” includes any one of the listed items, and all combinations of one or more of the listed items.

The terminology used herein is for the purpose of describing particular embodiments only and is not intended to be limiting of the present utility model. As used herein, the singular forms can include the plural forms as well, unless the context clearly indicates otherwise. Also, as used herein, “comprise” and/or “comprising” refers to the stated shape, steps, numbers, operations, members, elements, and/or addition or presence of these groups. It is not intended to exclude the presence or addition of one or more other shapes, steps, numbers, operations, members, elements, and/or addition or presence of these groups.

Although the terms first, second, etc. are used herein to describe various members, parts, regions, layers, and/or portions, it is obvious that these members, components, regions, layers, and/or portions are not limited by these terms. These terms are only used to distinguish one member, component, region, layer or portion from another region, layer or portion. Accordingly, the first member, component, region, layer or portion, which will be described in detail below, can refer to the second member, component, region, layer or portion without departing from the teachings of the present utility model.

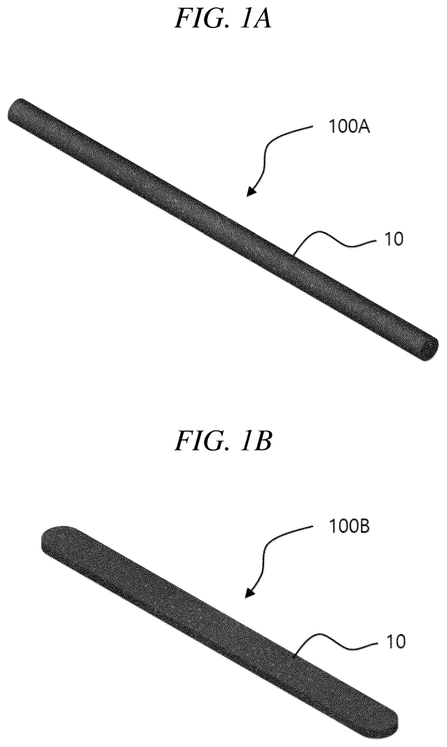

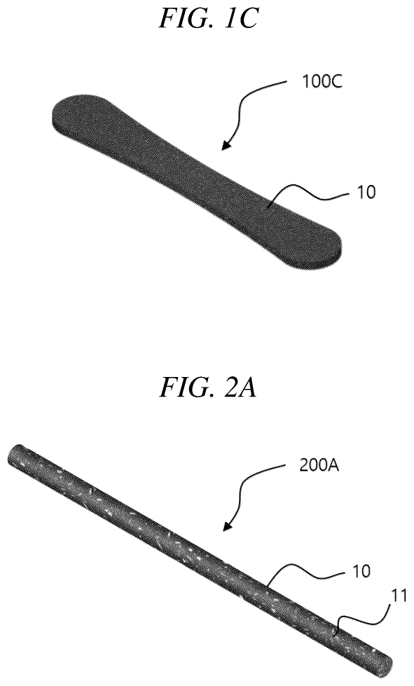

FIG. 1A to FIG. 1C are perspective views illustrating ice-cream bars 100A, 100B, and 100C according to various embodiments of the present utility model.

Referring to FIG. 1A, an ice-cream bar having a circular cross section according to one embodiment is disclosed. The ice-cream bar may be made by waste coffee powder and a biocompatible binder which is used for forming an ice-cream bar having a circular cross section by combining the waste coffee powder. The waste coffee powder may be obtained through obtaining a coffee sludge or coffee residues obtained after preparing coffee beverage, drying the coffee sludge or the coffee residues, and then pulverizing dried coffee sludge or coffee residues. Optionally, particle size distribution may be controlled via a grinding or milling process after the pulverizing process. Precise control of the particle size distribution is not required and may have a relatively large dispersion with an average diameter in a range of 10 μm to 2 mm.

The waste coffee powder may be mixed with the biocompatible binder by using a solvent, and may be manufactured through a molding process using molding or injection, and then a drying process. If necessary, the dried intermediate molded body may be heat treated in the range of about 50° C. to 90° C. to complete the drying process, and sterilization and impurity removal may be performed. Alternatively, before the waste coffee powder is mixed with the biocompatible binder, the waste coffee powder may be sterilized or dried in advance.

The biocompatible binder may be an organic binder, and preferably, may be a biodegradable substance. The biodegradable substance may include bio-derived soluble substance which is at least any one of chitosan, collagen, gelatin, hyaluronic acid(HA), alginic acid, pectin, carrageenan, chondroitin(sulfate), dextran(sulfate), polylysine, carboxymethyl titin, fibrin, agarose, pullulan and cellulose; biocompatible substances which is at leat any one of Polyvinylpyrrolidone(PVP), polyethylene glycol (PEG), polyvinyl alcohol(PVA), hydroxypropyl cellulose(HPC), hydroxyethyl cellulose (HEC), hydroxypropyl methylcellulose(HPMC), sodium carboxymethyl cellulose, polyalcohol, arabic gum, alginate, cyclodextrin, dextrin, glucose, fructose, starch, trehalose, glucose, maltose, lactose, lactulose, fructose, turanose, melitose, melezitose, dextran, sorbitol, xylitol, paratinite, polylactic acid, polyglycolic acid, polyethylene oxide, polyacrylic acid, polyacrylamide, polymethacrylic acid, and polymaleic acid; derivatives of the foregoing substances; or mixtures thereof. In another embodiment, the biocompatible binder may be a vegetable fiber or a known natural biopolymer extracted from any one or more of plants, including wood, cotton wool, ramie grass, corn foil, corn stalk, soybean meal. These substances are exemplary only, but the present utility model is not limited thereto. Non-toxic natural biosaccharides or polymers may also be used as the biocompatible substance of the present utility model.

The mixture of the waste coffee powder and the biocompatible binder may be prepared in a form of a slurry by a solvent. The solvent may be water or alcohol. In another embodiment, the solvent may be a non-toxic organic solvent that may be suitably selected according to the binder described above, and the present utility model is not limited to these examples

The waste coffee powder is included in 30% to 85 wt % of the total weight of the ice-cream bar, the rest may be the above-mentioned biocompatible binder. Within the composition range of the ice-cream bar, a maximum strength suitable for use within the range of −10° ° C. to 10° C., which is usable temperature of a conventional ice-cream bar, may be obtained. This will be described later in detail.

Referring to FIG. 1B, an ice-cream bar having a flat rectangular or rounded rectangular cross section according to another embodiment is disclosed. Referring to FIG. 1C, as another embodiment, an ice-cream bar having a shape capable of eating ice-cream is disclosed. As described above with reference to FIG. 1A, these ice-cream bars are also formed by combining waste coffee powder and a biocompatible binder, and their composition is as described above.

The matrix 10 containing the waste coffee powder and the biocompatible binder constituting the ice-cream bar described above with reference to FIGS. 1A to 1C may have various shapes, and the present utility model should not be limited to the shapes shown in FIGS. 1A to 1C. The ice-cream bars 100A, 100B, 100C may be used as spoons as well as handles for eating ice-cream, and may also be used as structures for other decorative purposes such as desserts.

Ice-cream is usually a low-temperature food which is consumed at less than 5° C., and in this case, the ice-cream bar according to the present utility model containing the waste coffee powder may be obtained enough strength suitable for use by the coldness of the ice-cream without complicated additional processes such as high temperature heat treatment or milling. Conventional ice-cream bars are formed of wooden bars that are at risk of depletion or plastics that cause environmental pollution, causing resource depletion and waste issue. But, according to the present utility model, if the ice-cream bar is manufactured from waste coffee powder, conventional resources can be replaced with the waste coffee powder, and the waste coffee powder can also be recycled in a simple process by using the property, i.e, strengthening itself by the coldess. In addition, according to the present utility model, even after the use of the ice-cream bar, that is, after the coldness disappears, the ice-cream bar easily loses its strength due to moisture originated from the ice-cream. Thus, it can have easy processibility, and is biodegradable, resulting in no additional environmental pollution. Consequently, while securing economics, application of eco-friendly waste coffee powder can be provided.

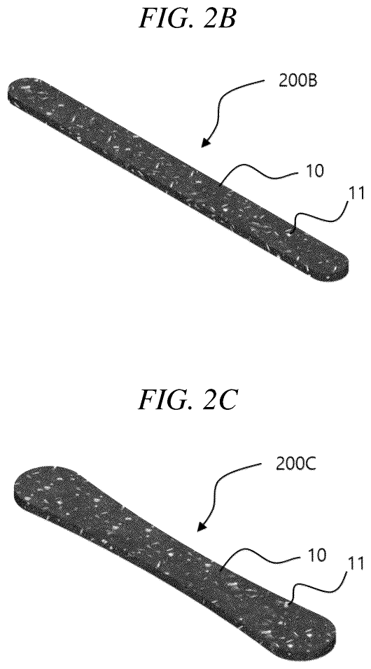

FIG. 2A to FIG. 2C are perspective views illustrating ice-cream bars 200A, 200B, and 200C according to various embodiments of the present utility model.

Referring to FIG. 2A-FIG. 2C, ice-cream bars 200A, 200B, 200C having the same shape as those of FIGS. 1A-1C are illustrated. The present utility model is not limited only to these shapes as described above.

The ice-cream bars 200A, 200B, 200C further comprise grain flour such as rice bran, rice husks, sawdust, foxtail millet, sorghum, corn or a mixture thereof as additive 11 together with the above-mentioned waste coffee powder and biocompatible binder. These substances may be uniformly or non-uniformly dispersed in the matrix 10 of the ice-cream bar formed by the whole waste coffee powder and binder. These additive substances may be distinguished from the coffee color of the matrix 10 according to their color to express colorful or peculiar textures that are not represented in conventional ice-cream bars, as shown in FIGS. 2A-2C.

The additives 11 dispersed in the matrix 10 may act as defects in the matrix, or The additives 11 may reduce the strengthening effect of the matrix based on the coldness effect of the ice-cream because of the different coefficient of thermal expansion between the waste coffee powder and the additives 11. Such a reduction of the strengening effect is clearly exhibited in the range of −10° ° C. to 10° C., and the additive may be added within a range of 35 wt % or less in consideration of the strength reduction effect.

### Experimental Example

Through drying and pulverizing process from waste coffee sludge, waste coffee powder having a particle size distribution in the range of 100 μm to 1 mm was obtained. Thereafter, binder was prepared by mixing cellulose extracted from corn, chitin or the above-described biocompatible binder by a predetermined ratio. Using water as a solvent, the waste coffee powder and the biocompatible binder were mixed to form a mixed slurry. Then, the mixed slurry was molded using a mold, and then drying and heat treatment at about 50° ° C. was performed. As another experimental example, rice bran and sawdust as additives were added to the solvent at a predetermined ratio to form a mixed slurry, and then, an ice-cream bar sample was formed by performing molding using the mold, drying, and heat treatment under the same conditions.

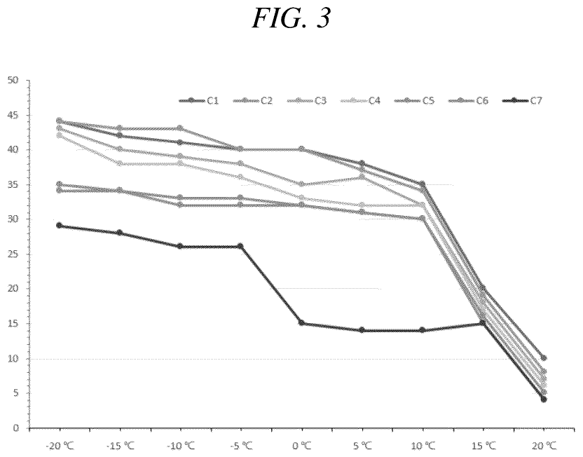

Table 1 shows the results of measuring the strength of the ice-cream bar according to the experimental example, and FIG. 3 is a graph showing the results of Table 1. Strength represents strength relative to strength at room temperature 25° C. and the strength at room temperature 25° ° C. was leveled to reference value 10.

TABLE 1

| | | | | | | | Com- |
|---|---|---|---|---|---|---|---|
| | Embodi- | Embodi- | Embodi- | Embodi- | Embodi- | Embodi- | parative |
| Temper- | ment 1 | ment 2 | ment 3 | ment 4 | ment 5 | ment 6 | example |
| ature | 0 wt % | 15 wt % | 20 wt % | 25 wt % | 30 wt % | 35 wt % | 40 wt % |
| −20° C. | 44 | 44 | 43 | 42 | 35 | 34 | 29 |
| −15° C. | 42 | 43 | 40 | 38 | 34 | 34 | 28 |
| −10° C. | 41 | 43 | 39 | 38 | 33 | 32 | 26 |
| −5° C. | 40 | 40 | 38 | 36 | 33 | 32 | 26 |
| 0° C. | 40 | 40 | 35 | 33 | 32 | 32 | 15 |
| 5° C. | 38 | 37 | 36 | 32 | 31 | 31 | 14 |
| 10° C. | 35 | 34 | 32 | 32 | 30 | 30 | 14 |
| 15° C. | 20 | 19 | 18 | 17 | 16 | 15 | 15 |
| 20° C. | 10 | 8 | 7 | 6 | 5 | 4 | 4 |

Referring to Table 1 and FIG. 3, a decrease in strength generally occurs as the temperature increases. This indicates that the coldness of the ice-cream increases the strength of the ice-cream bar, and the strength of the ice-cream bar suddenly decreases above 15° C., at which the ice-cream melts. Referring to the ice-cream bar containing no additives (Embodiment 1; indicated by curve C1), it may be seen that the strength is about 35 to 42 between −10° ° C. to 10° C. However, in the temperature range of 15° C. to 20° C., the strength of the ice-cream bar is drastically reduced. This means that after the ice-cream bar is used, it is easily decomposed in disposal thereof, which means less load for disposal, easier biodegradation and less environmental pollution as compared with ice-cream bars made of wood or plastic.

In another embodiment, when the additive is 15 wt % (example 2, curve C2), 20 wt % (example 3, curve C3), 25 wt % (example 4, curve C4)), and by 30 wt % (example 5, denoted by curve C5), and 35 wt % (example 6, denoted by curve C6) of total weight is added, as the content of the additive increases, reduction of the strength with temperature increasing takes place more drastically. However, it may be seen that in the case of these examples containing additives, strengths of 30 or more are all obtained within the range of −10° C. to 10° C., which is an temperature actual range for use and, thus they all are suitable. In addition, it may be observed that as the content of the additive increases, within the temperature range of 15° C. to 20° C., the strength is further reduced as compared with the strength of Embodiment 1 including only the waste coffee powder, thereby further reducing process load upon disposal after use, and facilitating decomposition rate.

However, in the case of the comparative example (curve C7) in which the amount of the additive reaches 40 wt %, the strength is not less than 30 within the range of −10° C. to 10° C., which is the actual use temperature. This is presumably due to the fact that as the temperature increases, moisture is generated from the ice-cream, thereby facilitating collapse of matrix via a swelling phenomenon of the matrix due to moisture absorption in the additive. Therefore, according to the present utility model, the amount of the additive is preferably limited to 35 wt % or less.

The present utility model described above is not limited to the above-described embodiment and the accompanying drawings, and it will be apparent to those having a common knowledge in the art to which the present utility model pertains that various substitutions, modifications, and changes within the scope without departing from the technological concepts of the present utility model may be made.

What is claimed is:

1. An ice-cream bar by recycling waste coffee, the ice-cream bar comprising
waste coffee powder; and
a biocompatible binder for combining the waste coffee powder to form the ice-cream bar.

2. The ice-cream bar by recycling waste coffee of the claim 1, wherein the biocompatible binder is a biodegradable binder.

3. The ice-cream bar by recycling waste coffee of the claim 2, wherein the biodegradable binder comprises bio-derived soluble substance which is at least any one of chitosan, collagen, gelatin, hyaluronic acid(HA), alginic acid, pectin, carrageenan, chondroitin(sulfate), dextran(sulfate), polylysine, carboxymethyl titin, fibrin, agarose, pullulan and cellulose; biocompatible substances which is at least any one of Polyvinylpyrrolidone(PVP), polyethylene glycol (PEG), polyvinyl alcohol(PVA), hydroxypropyl cellulose(HPC), hydroxyethyl cellulose (HEC), hydroxypropyl methylcellulose(HPMC), sodium carboxymethyl cellulose, polyalcohol, arabic gum, alginate, cyclodextrin, dextrin, glucose, fructose, starch, trehalose, glucose, maltose, lactose, lactulose, fructose, turanose, melitose, melezitose, dextran, sorbitol, xylitol, paratinite, polylactic acid, polyglycolic acid, polyethylene oxide, polyacrylic acid, polyacrylamide, polymethacrylic acid, and polymaleic acid; derivatives of the foregoing substances; or mixtures thereof.

4. The ice-cream bar by recycling waste coffee of the claim 2, wherein the biocompatible binder comprises plantcellurose extracted from any one or more of plants including wood, cotton wool, ramie grass, corn foil, corn stalk, soybean meal, or natural biopolymers.

5. The ice-cream bar by recycling waste coffee of the claim 1, wherein the waste coffee powder is in the range of 30 wt % to 85 wt % of the total weight of the ice-cream bar by recycling waste coffee.

6. The ice-cream bar by recycling waste coffee of the claim 1, wherein particles of the waste coffee powder have an average diameter in the range of 10 μm to 2 mm.

7. The ice-cream bar by recycling waste coffee of the claim 1, wherein the ice-cream bar further comprises additives including rice bran, rice husks, sawdust, grain flour or a mixture thereof.

8. The ice-cream bar by recycling waste coffee of the claim 7, wherein the additive is added within the range of 35 wt % or less relative to the total wt %.

9. The ice-cream bar by recycling waste coffee of the claim 1, wherein the ice-cream bar by recycling waste coffee constitutes a handle or spoon.

10. The ice-cream bar by recycling waste coffee of the claim 1, wherein the ice-cream bar by recycling waste coffee has any one of a circular cross section, a square cross section, and a rounded square cross section.
